(19) United States
(12) Patent Application Publication
(10) Pub. No.: US 2013/0052321 A1
(43) Pub. Date: Feb. 28, 2013

(54) APPARATUS AND METHOD FOR BREWING COFFEE

(71) Applicant: Yu-Kun LIU, Tainan City (TW)

(72) Inventor: Yu-Kun LIU, Tainan City (TW)

(21) Appl. No.: 13/215,674

(22) Filed: Aug. 23, 2011

(51) Int. Cl. A47J 31/44; A23F 5/26

(52) U.S. Cl. 426/433; 99/279

(57) ABSTRACT

An apparatus for brewing coffee includes: a filter cup movably supported on a supporting member of a main frame and configured with a receiving space; a control rod connected pivotally to an axle rod disposed above the supporting member; and a piston rod connected pivotally to the control rod and connected fixedly to a piston that is disposed fittingly and movably in the filter cup to divide the receiving space into upper and lower space parts. The piston is operable, based on rotation of the control rod, in a communicating state when moving upwardly and in a closed state when moving downwardly. When the control rod rotates to move downwardly the piston, ground coffee contained in the lower space part is pressed by the piston to the bottom of the lower space part. A method of brewing coffee performed by the apparatus is also disclosed.

### BACKGROUND OF THE INVENTION

1. Field of the Invention

The invention relates to an apparatus and method for brewing coffee, and more particularly, to an apparatus and method for brewing coffee used in brewing espresso.

2. Description of the Related Art

There are many different types of coffee machines. With respect to espresso machines which are used to produce the concentrated Italian coffee beverage referred to as espresso, steam or hot water is forced under pressure through finely ground coffee. At present, there are coffee machines with many different types of structures, and their brewing methods are also different.

Referring to FIGS. 1 to 4, a conventional manual piston-type coffee machine 9 disclosed in US Patent Application Publication No. US 2005/0172818 includes a seat 91, a driving device 92, and a filter 93. The seat 91 includes a cylinder 911, a filter plate 912 securely fixed within the cylinder 911 proximate to a lower end thereof, a pair of supports 913 extending downwardly and integrally from a lower end of said cylinder 911 on opposite sides thereof, and a bottom plate 914 connected to bottom ends of the supports 913 to bridge the same. The cylinder 911 has a mounting portion 915 formed in a lower portion thereof and positioned under the filter plate 912. The filter plate 912 has a plurality of filter holes 916.

The driving device 92 includes a piston 921 movably disposed in the cylinder 911 and disposed above the filter plate 912, a shaft plate 922 a lower end of which is fixedly connected to the piston 921, a pair of control rods 923 gear-meshed with each other and pivotably connected to opposite sides of the cylinder 911, and a pair of connecting rods 924 pivotably connected to an upper end of the shaft plate 922 on an upper end thereof and pivotably connected respectively to the control rods 923 on a lower end thereof.

The filter 93 is removably mounted to the lower portion of the cylinder 911, and includes a filter cup 932 that defines a receiving space 931 therein, and a handle 933 extending outwardly from a side of the filter cup 932. The filter cup 932 is disposed under the filter plate 912, and has an engaging portion 934 that is detachably engaged to the mounting portion 915.

When brewing coffee, ground coffee 90 is poured into the receiving space 931 in the filter 93, and a presser, e.g., a handheld presser, (not shown) is placed in the filter cup 932 to tightly press the ground coffee 90 to the bottom of the receiving space 931. Next, the filter 93 is mounted to the lower portion of the cylinder 911 and hot water is poured into the cylinder 911, as shown in FIG. 2. The control rods 923 are subsequently pulled upwardly such that the connecting rods 924 move the shaft plate 922 and the piston 921 upwardly, as shown in FIG. 3. As a result, the hot water passes around the periphery of the piston 921 and flows down to a location above the filter plate 912. Next, as shown in FIG. 4, the control rods 923 are pushed downwardly such that the piston 921 is moved downwardly to push and force the hot water to quickly move downwardly through the filter plate 912, into the receiving space 931 in the filter 93, to pass through the compacted ground coffee 90 and to drip downwardly, thereby obtaining espresso.

Since the above conventional coffee machine 9 does not have a structure to press the ground coffee 90 in the receiving space 931 in the filter 93, the filter 93 used to receive the ground coffee 90 must be separately mounted to the cylinder 911 of the seat 91. Moreover, the presser, which is not part of the structure of the conventional coffee machine 9, must be used to press the ground coffee 90 in the filter 93. That is, pressing of the ground coffee 90 must be completed outside the conventional coffee machine 9 by means of the presser. Hence, not only is it necessary for the user to exert a great deal of force, but this operation is troublesome for the user. Additionally, since the degree to which the ground coffee is pressed is not uniform from one batch to the next, a uniform extraction effect cannot be ensured. Moreover, since the piston 921 and the filter 93 are separately positioned above and below the filter 93, the piston 921 does not contact the ground coffee 90, and the hot water pressed by the piston 921 must pass through the filter plate 912 to contact the ground coffee 90. As a result, the pressurized hot water is obstructed before it brews the ground coffee 90. In this case, the hot water cannot quickly pass through the ground coffee 90, such that the concentration and flavor of the resulting espresso are not perfect.

### SUMMARY OF THE INVENTION

Therefore, an object of the present invention is to provide an apparatus and method for brewing coffee used in brewing espresso that allow for easy coffee brewing and that provide for a good coffee extraction effect.

According to one aspect of the present invention, an apparatus for brewing coffee comprises:

a main frame including a supporting member, and an axle rod disposed above the supporting member;

a filter cup movably supported on the supporting member and having a bottom wall, and an annular surrounding wall extending upwardly from a periphery of the bottom wall and cooperating with the bottom wall to define a receiving space therebetween, the bottom wall being formed with a plurality of filter holes in spatial communication with the receiving space;

a control rod connected pivotally to the axle rod and operable to rotate relative to the mainframe about the axle rod;

a piston rod having an upper end connected pivotally to the control rod such that the piston rod is movable in response to rotation of the control rod, and a lower end opposite to the upper end; and

a piston connected fixedly to the lower end of the piston rod such that the piston is movable with the piston rod, and disposed fittingly and movably in the filter cup such that the receiving space is divided into a lower space part adapted for receiving a quantity of ground coffee therein, and an upper space part, the piston being operable, based on rotation of the control rod, between a communicating state, where the upper space part is in spatial communication with the lower space part through the piston, and a closed state, where the upper space part is not in spatial communication with the lower space part, the piston being in the closed state when moving downwardly and in the communicating state when moving upwardly.

When the control rod rotates, an assembly of the piston and the piston rod is driven by the control rod to move downwardly such that the ground coffee in the lower space part is pressed by the piston to the bottom of the lower space part.

According to another aspect of the present invention, there is provided a method of brewing coffee performed by the aforesaid apparatus. The method comprises the steps of:

a) rotating the control rod to move downwardly the piston so as to press the ground coffee in the lower space part of the receiving space in the filter cup into a compacted block;

b) receiving hot water in the upper space part of the receiving space in the filter cup, and rotating the control rod to move the piston upwardly to allow spatial communication between the upper space part and the lower space apart such that the hot water in the upper space part flows into the lower space part through the piston; and

c) rotating the control rod to move the piston downwardly such that the piston in the closed state pushes and forces the hot water in the lower space part to quickly pass through the compacted ground coffee and drip downwardly out of the filter cup, thereby obtaining extracted coffee.

### BRIEF DESCRIPTION OF THE DRAWINGS

Other features and advantages of the present invention will become apparent in the following detailed description of the preferred embodiment with reference to the accompanying drawings, of which:

FIG. 1 is a partially exploded perspective view of a conventional coffee machine disclosed in US Patent Application Publication No. US 2005/0172818;

FIGS. 2 to 4 are partially schematic sectional views showing the conventional coffee machine in different states, respectively;

FIG. 5 is a partially exploded perspective view showing the preferred embodiment of an apparatus for brewing coffee according to the present invention;

FIG. 6 is a partially schematic sectional view of the preferred embodiment;

FIG. 7 is a fragmentary, partially schematic sectional view showing the preferred embodiment in a state in which ground coffee has been placed in a lower space part in a filter cup;

FIG. 8 is a fragmentary, partially schematic sectional view showing the preferred embodiment in a state in which the ground coffee is pressed into a compacted block;

FIG. 9 is a fragmentary, partially schematic sectional view showing the preferred embodiment in a state in which hot water is poured into an upper space part in the filter cup;

FIG. 10 is a fragmentary, partially schematic sectional view showing the preferred embodiment in a state in which the hot water in the upper space part flows into the lower space part through a piston;

FIG. 11 is a fragmentary, partially schematic sectional view showing the preferred embodiment in a state in which the hot water in the lower space part is pushed and forced to pass through the compacted ground coffee and drip downwardly out of the filter cup; and

FIG. 12 is a flowchart of a method of brewing coffee performed by the apparatus of the preferred embodiment.

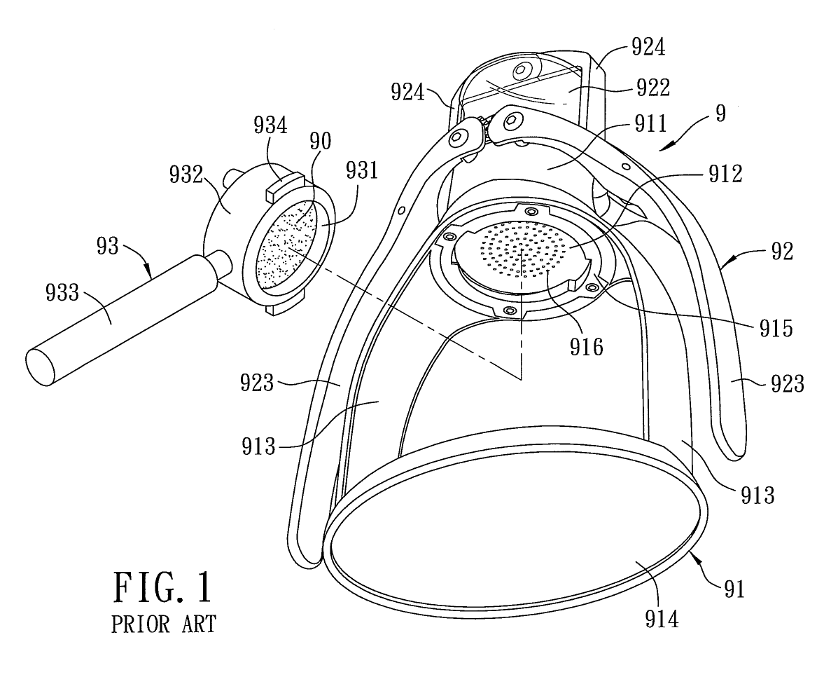

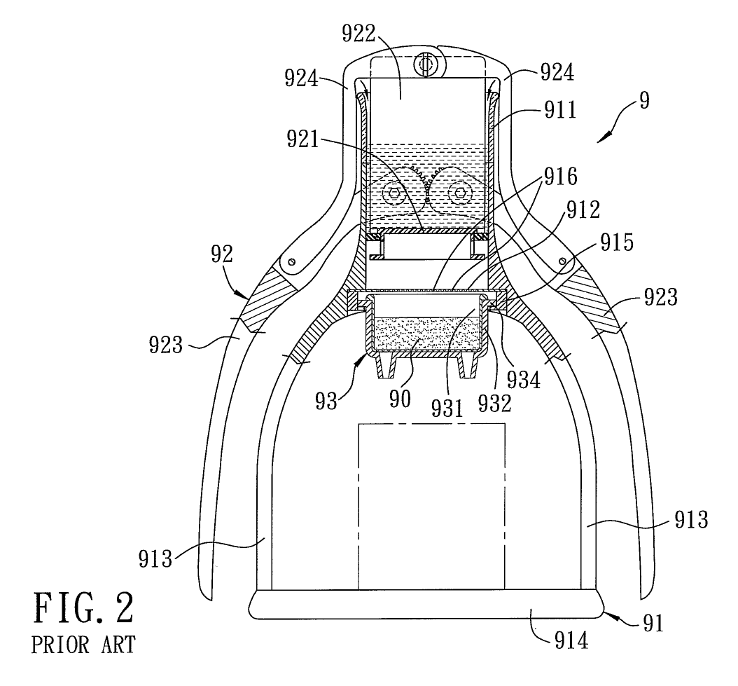

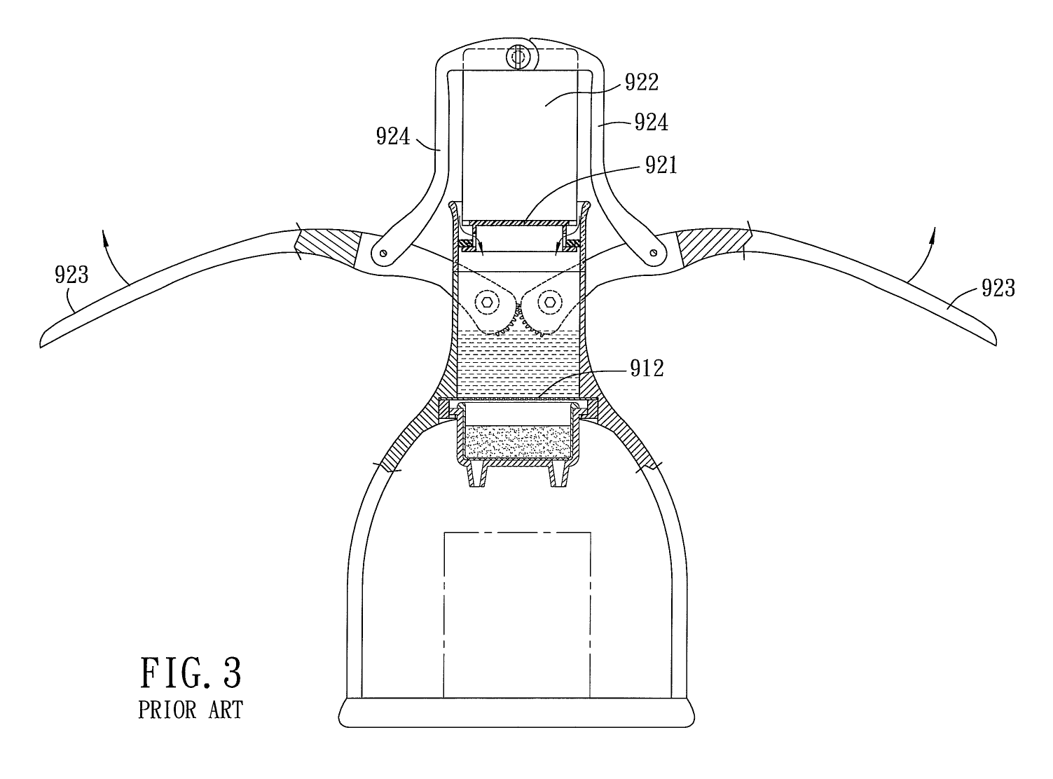

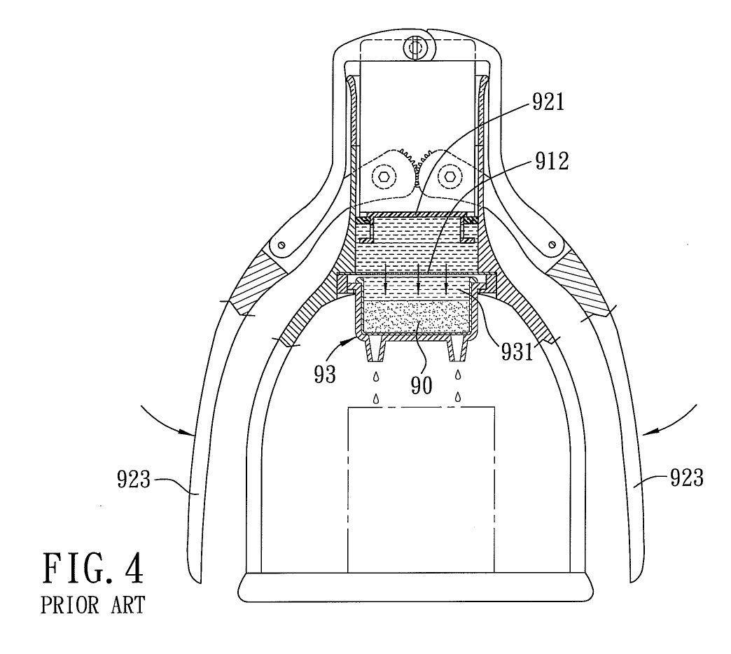

### DETAILED DESCRIPTION OF THE PREFERRED EMBODIMENT

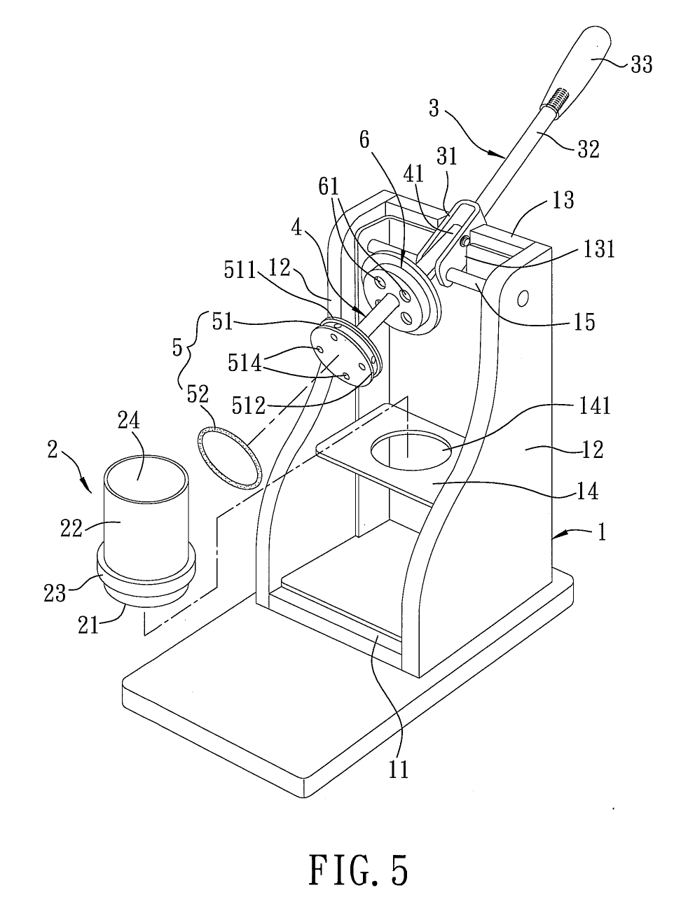

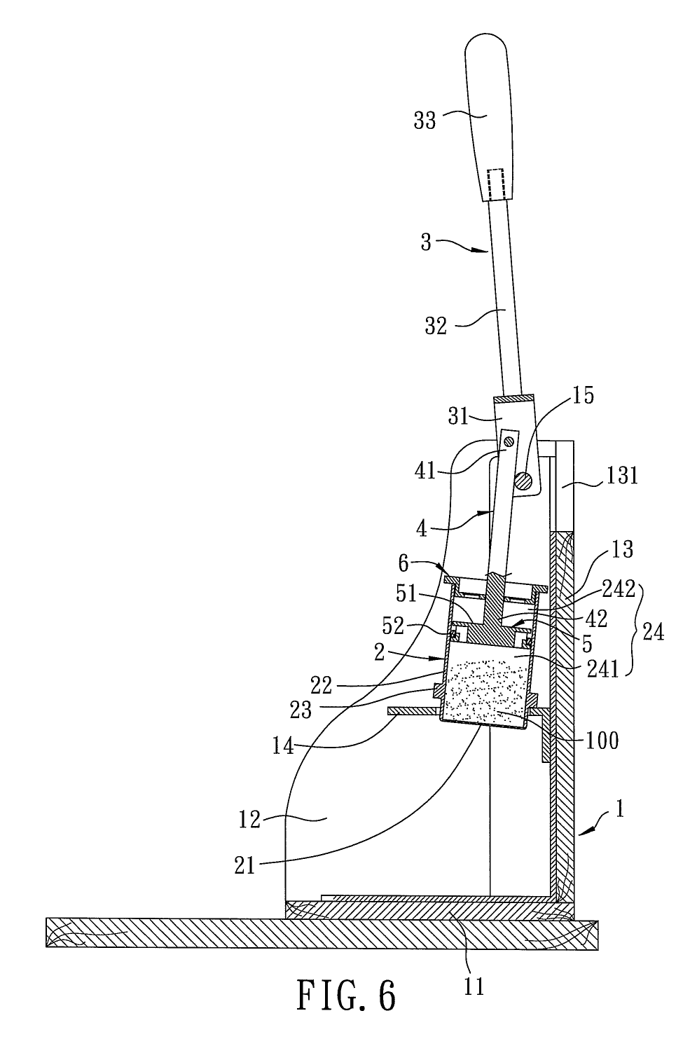

Referring to FIGS. 5 to 7, the preferred embodiment of an apparatus for brewing coffee, such as espresso, according to the present invention is shown to include a main frame 1, a filter cup 2, a control rod 3, a piston rod 4, a piston 5, and a cover 6.

In this embodiment, the main frame 1 includes a base plate 11, opposite lateral plates and a rear plate uprightly standing on the base plate 11, and a supporting member 14, which is in the form of a plate, connected among the lateral plate 12 and the rear plate 13 and disposed horizontally above the base plate 11, and an axle rod 15 extending horizontally between the lateral plates 12 and disposed above the supporting member 14. The supporting member 14 is formed with a central mounting hole 141. The rear plate 13 has a top end formed with a notch 131

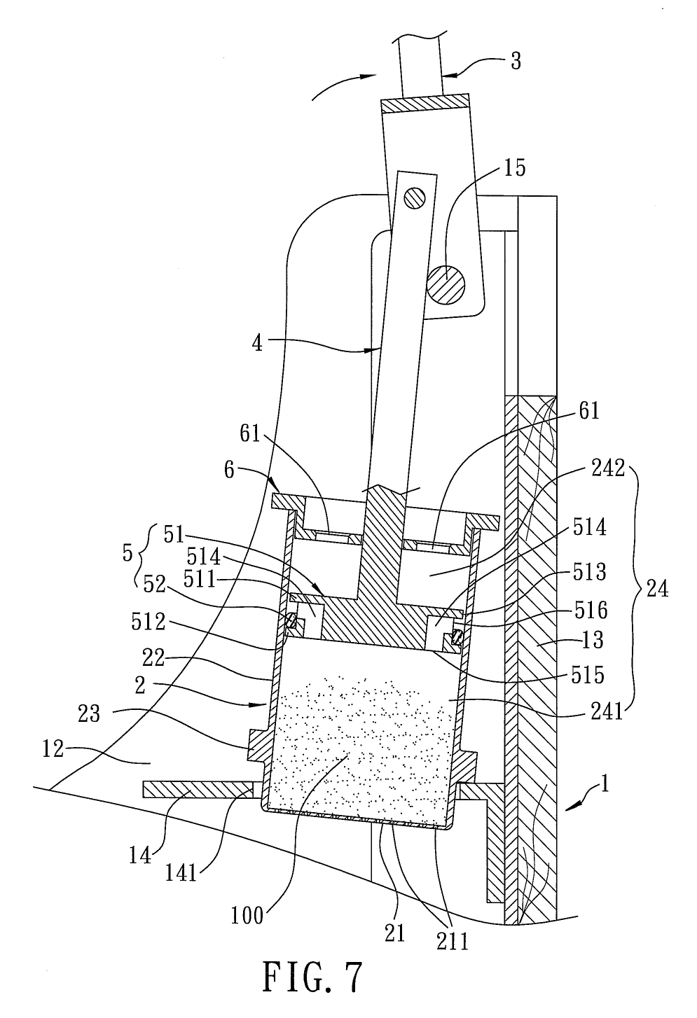

The filter cup 2 is mounted in the mounting hole 141 in the supporting member 14, and is movably supported on the supporting member 14. The filter cup 2 has a bottom wall 21, and an annular surrounding wall 22 extending upwardly from a periphery of the surrounding wall 22 and cooperating with the bottom wall 21 to define a receiving space 24 therebetween. The bottom wall 21 is formed with a plurality of filter holes 211 (see FIG. 7) in spatial communication with the receiving space 24. In this embodiment, the filter cup 2 further has an annular flange 23 extending outwardly and radially from the surrounding wall 22 and having an outer diameter greater than a diameter of the mounting hole 141 such that the filter cup 2 is movably supported on the supporting member 14 through abutment of at least one part of the annular flange 23 against the supporting member 14.

The control rod 3 is connected pivotally to the axle rod 15, and is operable to rotate relative to the main frame 1 about the axle rod 15. In this embodiment, the control rod 3 functions as a lever, and has a U-shaped pivot end portion 31, a detachable operating end portion 33 and an intermediate portion 32 interconnecting the pivot end portion 31 and the operating end portion 33. Thus, the length of the control rod 3 can be changed by replacement of the operating end portion 33. In other embodiments, the control rod 3 can be formed integrally such that the control rod 3 has a fixed length. In addition, the pivot end portion 31 of the control rod 3 can be positioned in the notch 131 in the rear plate 13 of the main frame 1 (see FIG. 5).

The piston rod 4 has an upper end 41 connected pivotally to the pivot end portion 31 of the control rod 3 such that the piston rod 4 is movable in response to rotation of the control rod 3, and a lower end 42 opposite to the upper end 41.

The piston 5 is connected fixedly to the lower end 42 of the piston rod 41 such that the piston 5 is movable with the piston rod 4, and is disposed fittingly and movably in the filter cup 2 such that the receiving space 24 is divided into a lower space part 241 adapted for receiving a quantity of ground coffee 100 therein, and an upper space part 242. The piston 5 is operable, based on rotation of the control rod 3, between a communicating state, where the upper space part 242 is in spatial communication with the lower space part 241 through the piston 5, and a closed state, where the upper space part 242 is not in spatial communication with the lower space part 241. The piston 5 is in the closed state when moving downwardly and in the communicating state when moving upwardly.

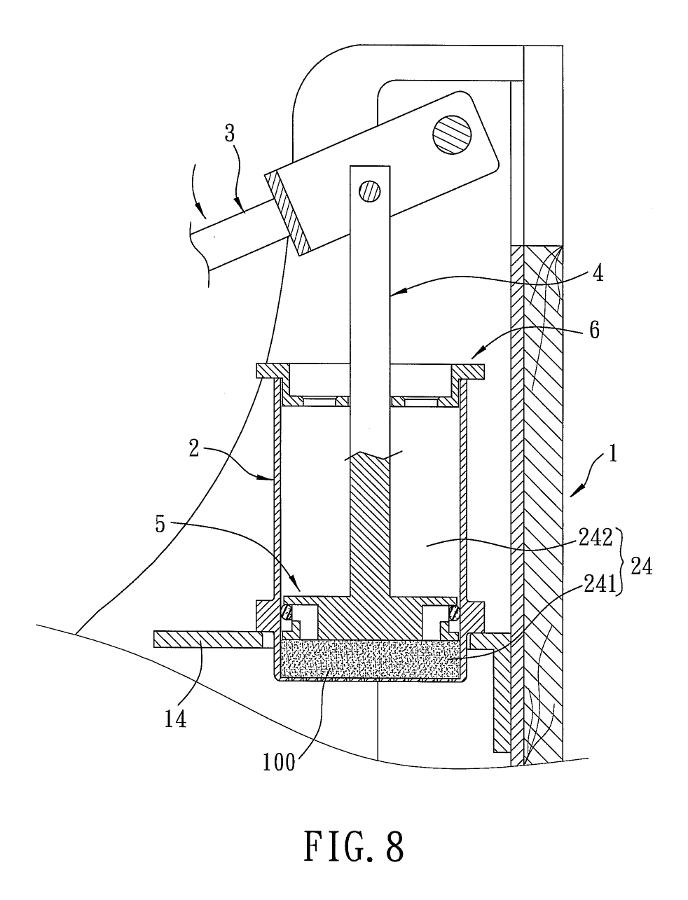

In this embodiment, the piston 5 includes a piston body 51 and a seal ring 52. The piston body 51 has a lower rim flange 512, and an upper rim flange 511 spaced apart from the surrounding wall 22 of the filter cup 2 so that an annular gap 513 is formed between the surrounding wall 22 of the filter cup 2 and the upper rim flange 511. As shown in FIG. 7, the piston body 51 is formed with a plurality of flow channels 514, each of which has a first end 515 in spatial communication with the lower space part 241 of the receiving space 24 in the filter cup 2, and a second end 516 opposite to the first end 515 and adjacent to the upper rim flange 511. The seal ring 52, such as an o-ring made from rubber, is located between the piston body 51 and the surrounding wall 22 of the filter cup 2, and is movable between the upper and lower rim flanges 511, 512. An axial spacing between the upper and lower rim flange 511, 512 exceeds an axial dimension of the seal ring 52. As shown in FIG. 7, when the piston 5 moves upwardly in response to rotation of the control rod 3 in a first direction, such as a clockwise direction, the seal ring 52 moves to lie against the lower rim flange 512 of the piston body 51 such that the gap 513 is in spatial communication with the second ends 516 of the flow channels 514 in the piston body 51 to thereby maintain the piston 5 in the communicating state. As shown in FIG. 8, when the piston 5 moves downwardly in response to rotation of the control rod 3 in a second direction opposite to the first direction, such as a counterclockwise direction, the seal ring 52 moves to lie against the upper rim flange 511 such that the gap 513 is blocked by the seal ring 52 to thereby maintain the piston 5 in the closed state.

It is noted that, when the control rod 3 is manually operated to rotate in the counterclockwise direction, an assembly of the piston 5 and the piston rod 4 is driven by the control rod 3 to move downwardly such that the ground coffee 100 in the lower space part 241 is pressed by the piston 5 to the bottom of the lower space part 241 and is formed into a compacted block. Therefore, the presser used in the aforesaid conventional coffee machine is not required.

The cover 6 is sleeved movably on the piston rod 4, and is disposed on top of the surrounding wall 22 of the filter cup 2. The cover 6 is formed with a plurality of inlet holes 61 in spatial communication with the upper space part 242 of the receiving space 24 in the filter cup.

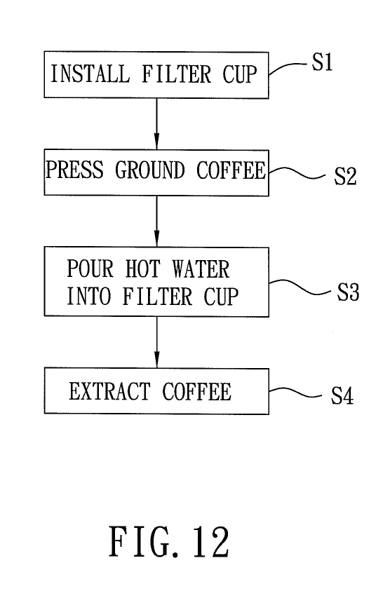

FIG. 12 illustrates a flowchart of a method of brewing coffee performed by the apparatus of the preferred embodiment.

In step S1, the piston 5 is placed into the filter cup 2 contained with the ground coffee 100, and the filter cup 2 is placed on the supporting member 14 of the main frame, as shown in FIG. 7. In this case, since the piston rod 4 abuts against the axle rod 15, the filter cup 2 moves with the assembly of the piston rod 4 and the piston 5 to incline relative to the supporting member 14.

In step S2, the control rod 3 is manually operated to rotate in the counterclockwise direction to move the piston 5 downwardly to press the ground coffee in the lower space part 241 of the receiving space 24 into a compacted block, as shown in FIG. 8. In this state, the piston 5 is in the closed state.

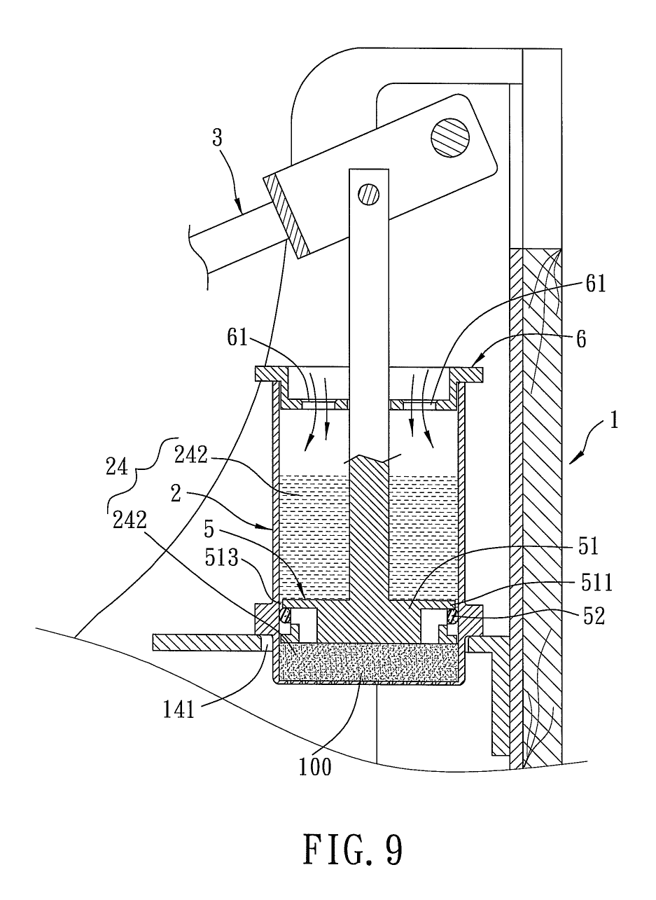

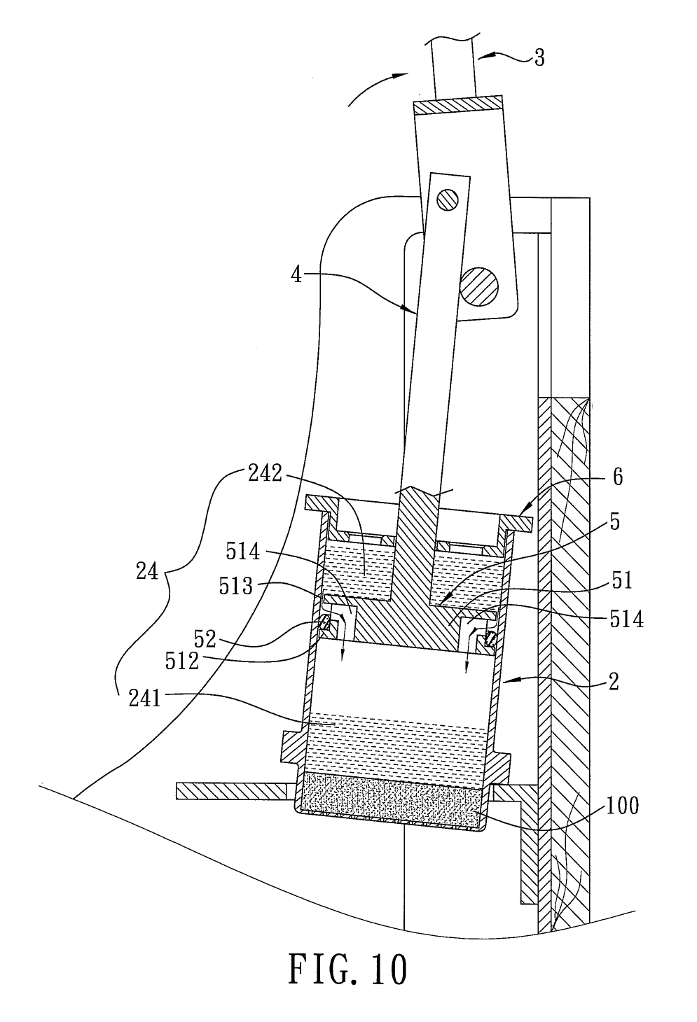

In step S3, hot water is poured into the upper space part 242 of the receiving space 24 through the inlet holes 61 in the cover 6, as shown in FIG. 9. Subsequently, the control rod 3 is manually operated to rotate in the clockwise direction to move the piston 5 upwardly. In this case, since the piston 5 is in the communication state, the hot water in the upper space part 242 flows downwardly into the lower space part 241 through the gap 513 and the flow channels 514 in the piston body 51, as shown in FIG. 10.

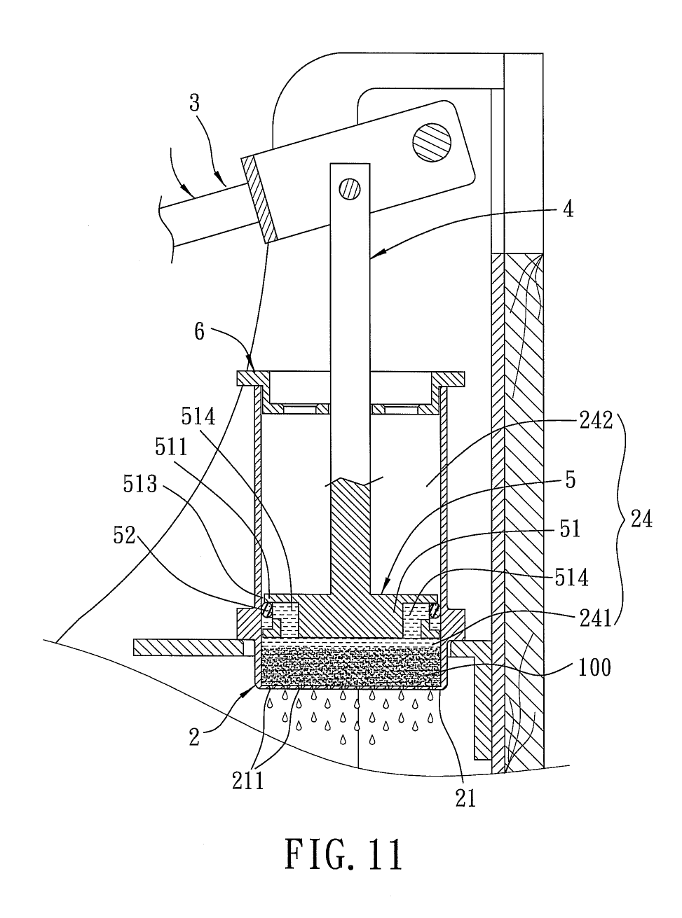

In step S4, the control rod 3 is manually operated to rotate in the counterclockwise direction to move the piston 5 downwardly. In this case, the piston 5 is in the closed state. Thus, as shown in FIG. 11, the piston 5 pushes and forces the hot water in the lower space part 241 to quickly pass through the compacted ground coffee 100 and drip downwardly out of the filter cup 2 through the filter holes 211 in the bottom wall 21 of the filter cup 2, thereby obtaining extracted coffee that can be collected by a cup (not shown) disposed under the filter cup 2.

In sum, the apparatus of the present invention has a relatively simple structure and can be easily installed compared to the aforesaid conventional coffee machine. When brewing coffee, the apparatus is easily operated to brew coffee through rotation of the control rod 3 without a handheld presser for pressing the ground coffee 100. Additionally, the ground coffee 100 can be pressed to a substantially uniform degree in each operation of the control rod 3. Therefore, a uniform extraction effect can be ensured. Moreover, since the hot water pressurized by the piston 5 directly brews the compacted ground coffee 100, the extracted coffee has superior concentration and flavor.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An apparatus for brewing coffee comprising:
a main frame including a supporting member, and an axle rod disposed above said supporting member;
a filter cup movably supported on said supporting member and having a bottom wall, and an annular surrounding wall extending upwardly from a periphery of said bottom wall and cooperating with said bottom wall to define a receiving space therebetween, said bottom wall being formed with a plurality of filter holes in spatial communication with said receiving space;
a control rod connected pivotally to said axle rod and operable to rotate relative to said main frame about said axle rod;
a piston rod having an upper end connected pivotally to said control rod such that said piston rod is movable in response to rotation of said control rod, and a lower end opposite to said upper end; and
a piston connected fixedly to said lower end of said piston rod such that said piston is movable with said piston rod, and disposed fittingly and movably in said filter cup such that said receiving space is divided into a lower space part adapted for receiving a quantity of ground coffee therein, and an upper space part, said piston being operable, based on rotation of said control rod, between a communicating state, where said upper space part is in spatial communication with said lower space part through said piston, and a closed state, where said upper space part is not in spatial communication with said lower space part, said piston being in the closed state when moving downwardly and in the communicating state when moving upwardly;
wherein, when said control rod rotates, an assembly of said piston and said piston rod is driven by said control rod to move downwardly such that the ground coffee in said lower space part is pressed by said piston to the bottom of said lower space part;
wherein said piston includes
a piston body having a lower rim flange, and an upper rim flange spaced apart from said surrounding wall of said filter cup so that an annular gap is formed between said surrounding wall of said filter cup and said upper rim flange, said piston body being formed with at least one flow channel that has a first end in spatial communication with said lower space part of said receiving space, and a second end opposite to said first end and adjacent to said upper rim flange, and
a seal ring located between said piston body and said surrounding wall of said filter cup and movable between said upper and lower rim flanges, an axial spacing between said upper and lower rim flanges exceeding an axial dimension of said seal ring;
wherein, when said piston moves upwardly in response to rotation of said control rod, said seal ring moves to lie against said lower rim flange of said piston body such that that said gap is in spatial communication with said second end of said flow channel in said piston body to thereby maintain said piston in the communicating state; and
wherein, when said piston moves downwardly in response to rotation of said control rod, said seal ring moves to lie against said upper rim flange of said piston body such that said gap is blocked by said seal ring to thereby maintain said piston in the closed state.

2. The apparatus as claimed in claim 1, wherein:
said supporting member of said main frame is in the form of a plate, and is formed with a mounting hole for mounting said filter cup therein;
said filter cup further has an annular flange extending outwardly and radially from said surrounding wall, and having an outer diameter greater than a diameter of said mounting hole such that the filter cup is supported on said supporting member through abutment of at least one part of said annular flange against said supporting member.

3. The apparatus as claimed in claim 1, wherein said main frame further includes opposite lateral plates, and a rear plate, said supporting member being disposed horizontally among said lateral plates and said rear plate.

4. The apparatus as claimed in claim 1, further comprising a cover sleeved movably on said piston rod and disposed on top of said surrounding wall of said filter cap, said cover being formed with a plurality of inlet holes in spatial communication with said upper space part of said receiving space in said filter cup.

5. The apparatus as claimed in claim 1, wherein said control rod has a pivot end portion connected pivotally to said axle rod, and a detachable operating end portion.

6. A method of brewing coffee performed by the apparatus as claimed in claim 1, said method comprising the steps of :
a) rotating the control rod to move downwardly the piston so as to press the ground coffee in the lower space part of the receiving space in the filter cup into a compacted block;
b) receiving hot water in the upper space part of the receiving space in the filter cup, and rotating the control rod to move the piston upwardly to allow spatial communication between the upper space part and the lower space apart such that the hot water in the upper space part flows into the lower space part through the piston; and
c) rotating the control rod to move downwardly the piston such that the piston in the closed state pushes and forces the hot water in the lower space part to quickly pass through the compacted ground coffee and drip downwardly out of the filter cup, thereby obtaining extracted coffee.
